(19) United States
(12) Patent Application Publication
(10) Pub. No.: US 2008/0096097 A1
(43) Pub. Date: Apr. 24, 2008

(54) Novel narrowband crystal UV filters

(76) Inventor: Narsingh Bahadur Singh, Ellicott City, MD (US)

Correspondence Address: ANDREWS KURTH LLP;Intellectual Property Department, Suite 1100, 1350 I Street, N.W., Washington, DC, 20005, US

(21) Appl. No.: 11/580,834

(22) Filed: Oct. 16, 2006

(51) Int. Cl. H01M 10/34

(52) U.S. Cl. 429/59

(57) ABSTRACT

Crystals having a narrowband transmission window in the UV range and methods for producing such crystals are disclosed. The method comprises the steps of preparing a saturated nutrient solution of a nickel compound and a dopant salt; and incubating the nutrient solution under conditions suitable for crystal growth. The nickel compound is nickel silicon fluoride, nickel fluoroborate, or potassium nickel sulfate. The dopant salt is a salt of cobalt, calcium, barium, strontium, lead, copper, germanium, praseodymium, neodymium, zinc, lithium, potassium, sodium, rubidium, or cesium. The doped nickel compounds crystals have a narrow transmission window in the UV range and can be used as filters for optical sensors in applications such as the passive missile approach warning systems.

### TECHNICAL FIELD

The invention relates generally to ultraviolet (UV) crystal filters for optical sensors, and more particularly to crystals having high transmission, narrowband windows in the UV range.

### BACKGROUND OF THE INVENTION

There are a variety of devices which use ultraviolet (UV) light filters that allow selected wavelengths of light to pass through. For example, such filters are used in passive missile approach warning systems (PMAWS) which locate and track sources of ultra-violet energy, enabling the system to distinguish the plume of an incoming missile from other UV sources that pose no threat. The efficiency of the missile approach warning system depends on the efficiency, stability and quality of the UV filters.

All UV sensors have finite sensitivity to visible radiations. It is very important for a UV sensor to discriminate against the visible radiation so as to maximize UV sensitivity while minimizing false signals caused by visible light sources. Therefore, the UV filters should have high transmittance in the UV spectral region and have strong absorption at longer wavelengths. Moreover, the filters should have high thermal stability because the UV sensors may be used in environments with high temperatures, such as aircrafts parked in tropical and desert areas.

It is known that certain transition metal ions, such as Ni²⁺ and Co²⁺, absorb visible radiations and transit in certain UV range. These metals have been used in UV filters such as Corning 9863 glass which is a UV transmitting glass doped with Ni²⁺ and Co²⁺. The doped glass provide effective blocking of visible radiations. However, there is a significant absorption in 250-300 nm wavelength region that sacrifices in-band transmittance and reduces the sensitivity of the detector. There still exists a need for UV filter materials with filter transmittance in the wavelength range of interests and higher temperature stability.

### SUMMARY OF THE INVENTION

One aspect of the present invention relates to a method for producing a crystal with a transmission window in the UV range. The method comprises the steps of (1) preparing a first saturated nutrient solution of a nickel compound and a first dopant salt; and

(2) incubating the first nutrient solution under conditions suitable for crystal growth, wherein the nickel compound is selected from the group consisting of nickel silicon fluoride, nickel fluoroborate, and potassium nickel sulfate, and wherein said dopant salt is selected from the group consisting of salts of cobalt, calcium, barium, strontium, lead, copper, germanium, praseodymium, neodymium, zinc, lithium, potassium, sodium, rubidium, and cesium.

In one embodiment, the nickel compound is nickel fluoroborate, the dopant salt is cobalt fluoroborate, and the crystal has a formula of NiₓCo₍₁₋ₓ₎(BF₄)₂.6H₂O, where 0<x<1.

In another embodiment, the nickel compound is potassium nickel sulfate, the dopant salt is potassium cobalt sulfate, and the crystal has a formula of K₂NiₓCo₍₁₋ₓ₎(SO₄)₂.6H₂O, where 0<x<1.

In another embodiment, the method further comprises the steps of (3) preparing a saturated second nutrient solution of a doped nickel compound obtained from step (2) and a second dopant salt; and (4) incubating the second nutrient solution under conditions suitable for crystal growth, wherein said second dopant is different from said first dopant.

In one embodiment, the doped nickel compound obtained from step (2) is one of NiₓCo₍₁₋ₓ₎SiF₆.6H₂O and K₂NiₓCo₍₁₋ₓ₎(SO₄)₂.6H₂O, where 0<x<1, and wherein said second dopant salt is one of PbCO₃ and CaCO₃.

Another aspect of the present invention relates to crystals produced by the method of the present invention and UV filters fabricated from the crystals.

### DETAILED DESCRIPTION OF DRAWINGS

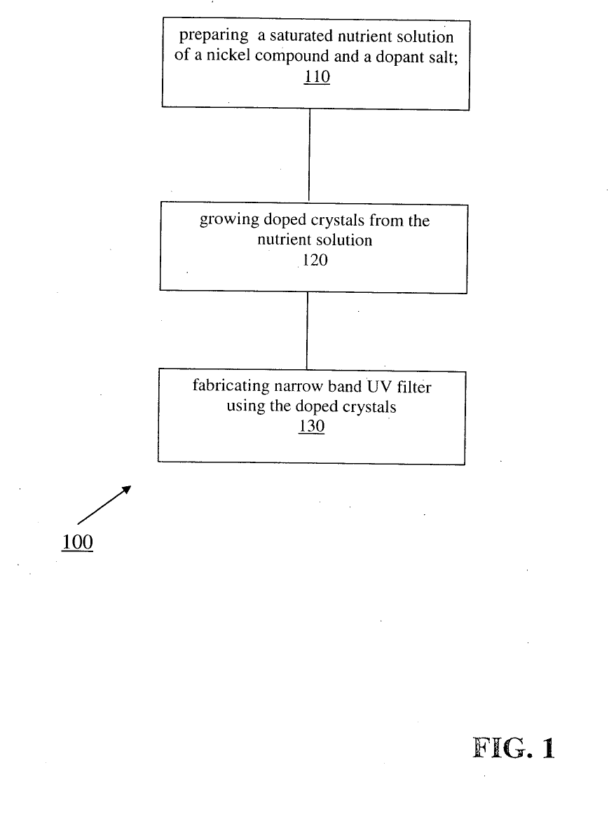

FIG. 1 is a schematic showing a method for producing single-doped, nickel compound crystal filters suitable for narrowband UV sensors.

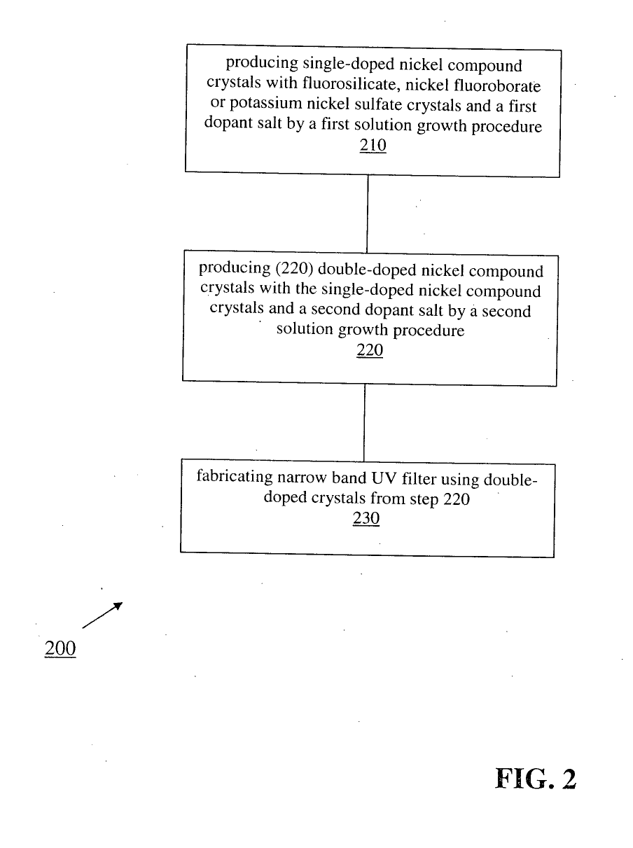

FIG. 2 is a schematic showing a method for producing double-doped, nickel compound crystal filters suitable for narrowband UV sensors.

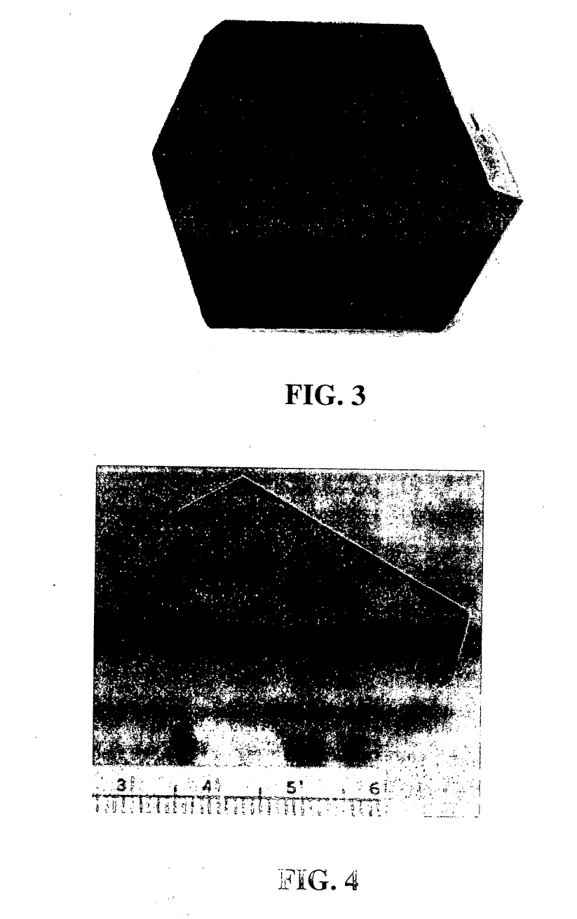

FIG. 3 is a picture of recrystallized NiSiF₆.6H₂O crystals.

FIG. 4 is a picture of cobalt doped NiSiF₆.6H₂O (NiₓCo₍₁₋ₓ₎SiF₆.6H₂O) crystals.

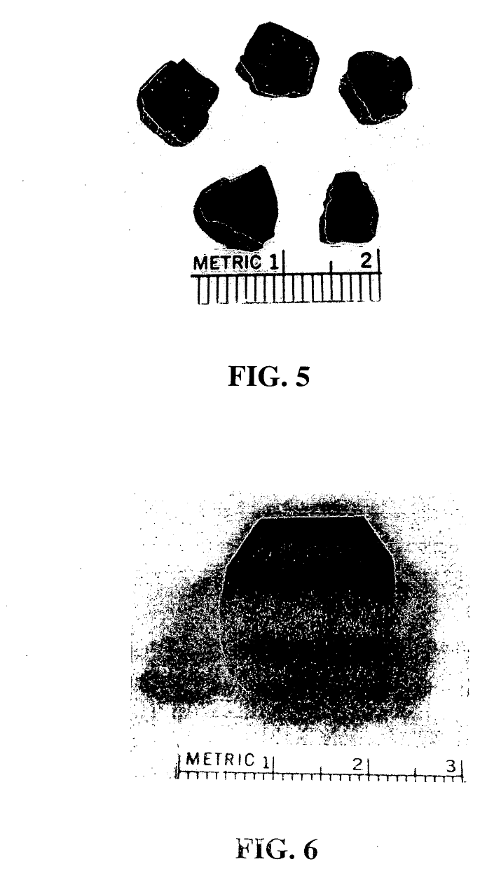

FIG. 5 is a picture of recrystallized K₂Ni(SO₄)₂.6H₂O crystals.

FIG. 6 is a picture of cobalt doped K₂Ni(SO₄)₂.6H₂O (K₂NiₓCo₍₁₋ₓ₎₎(SO₄)₂.6H₂O) crystals.

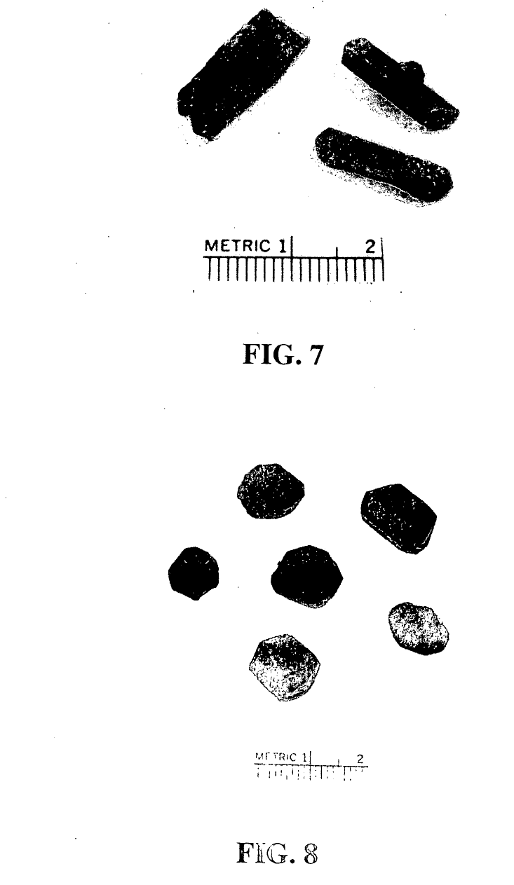

FIG. 7 is a picture of recrystallized Ni(BF₄)₂.6H₂O crystals.

FIG. 8 is a picture of cobalt doped Ni(BF₄)₂.6H₂O (NiₓCo₍₁₋ₓ₎₎(BF₄)₂.6H₂O) crystals.

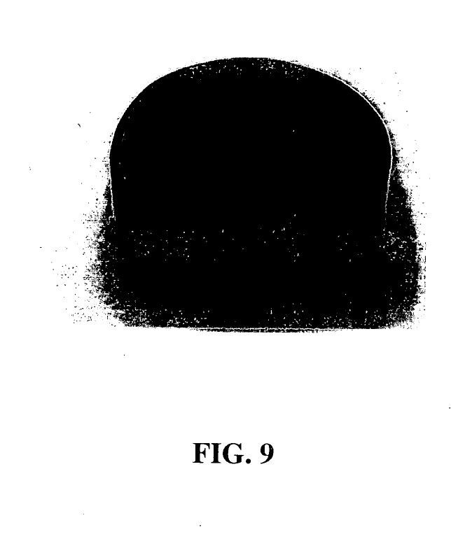

FIG. 9 is a picture of a disc filter fabricated from NiₓCo₍₁₋ₓ₎SiF₆.6H₂O crystals.

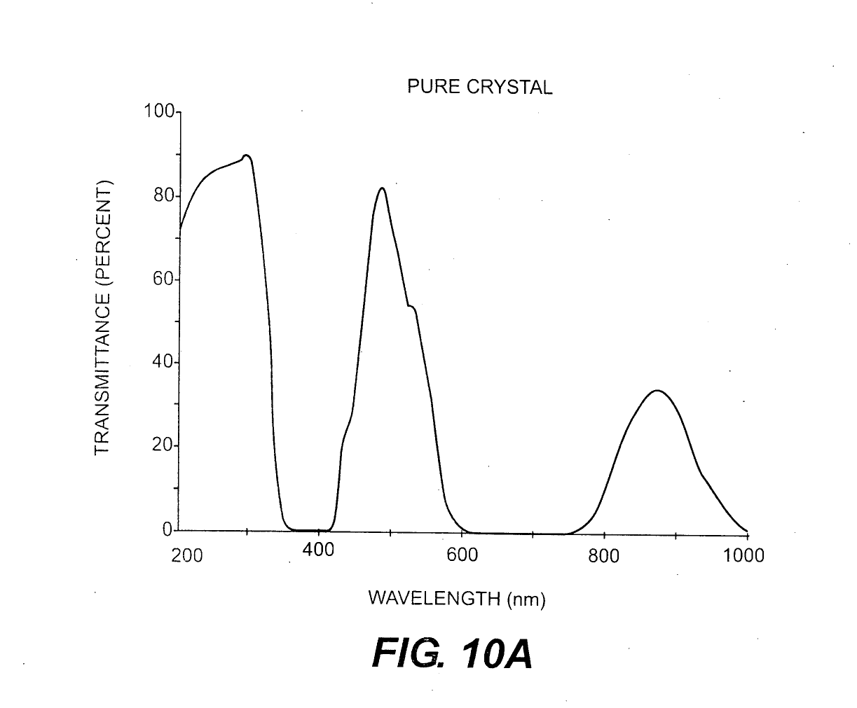

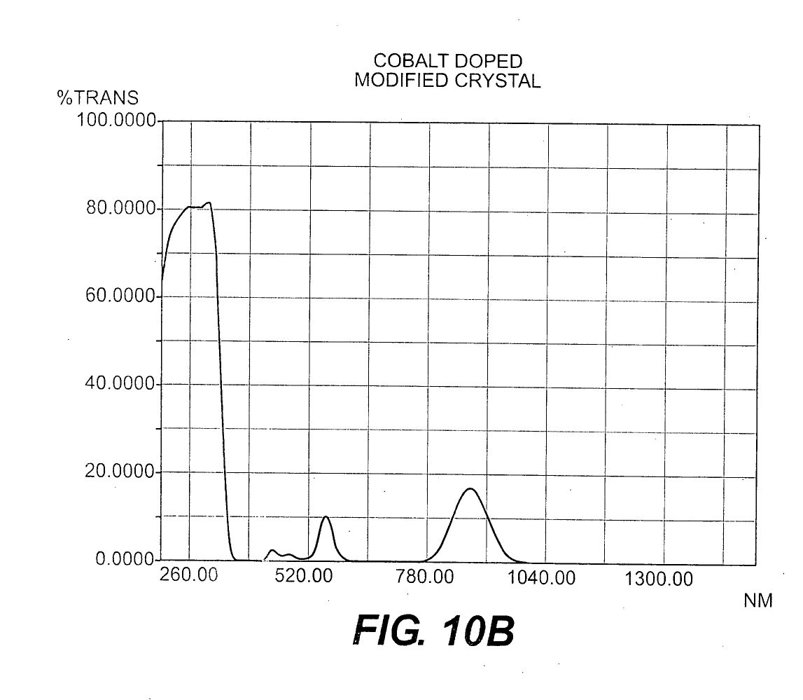

FIGS. 10A and 10B are absorption curves showing spectral characteristics of pure nickel fluorosilicate (FIG. 10A) and nickel/cobalt fluorosilicate (FIG. 10B).

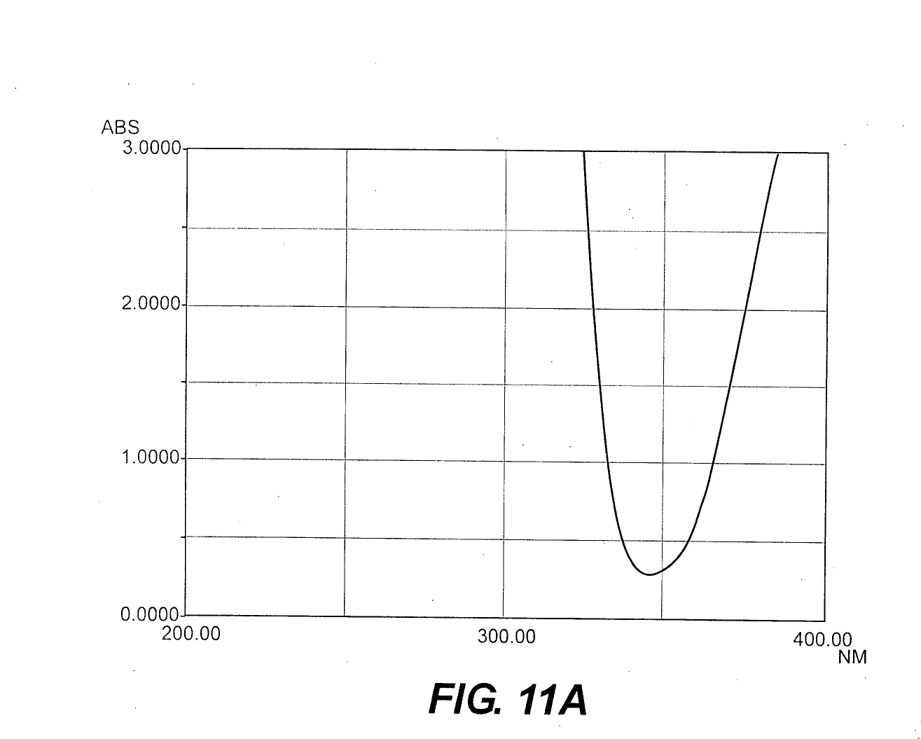

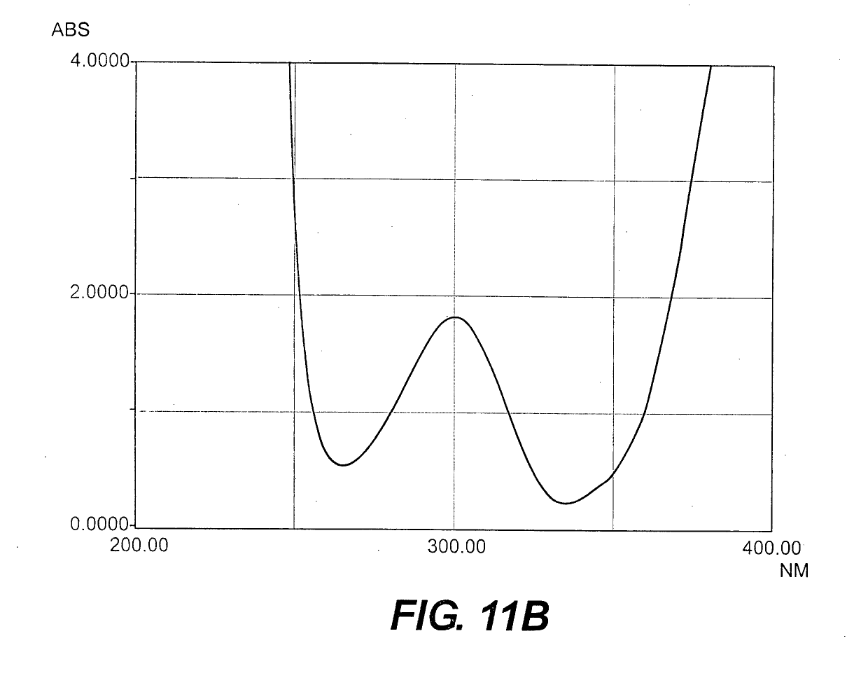

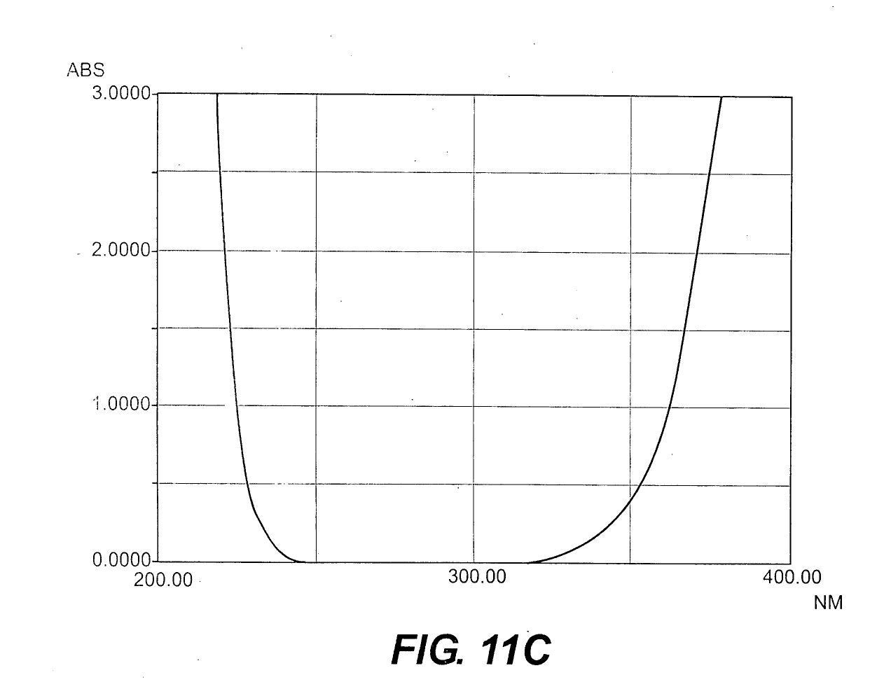

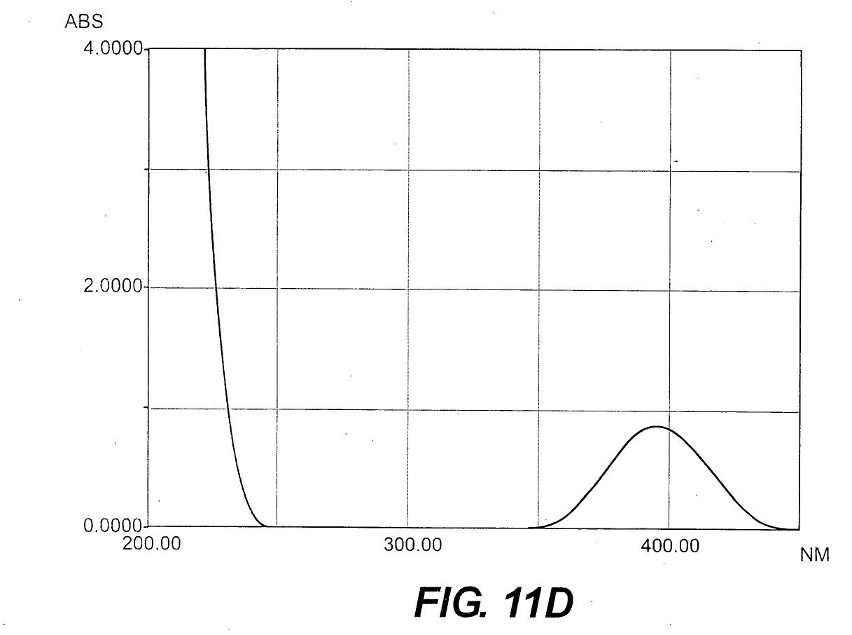

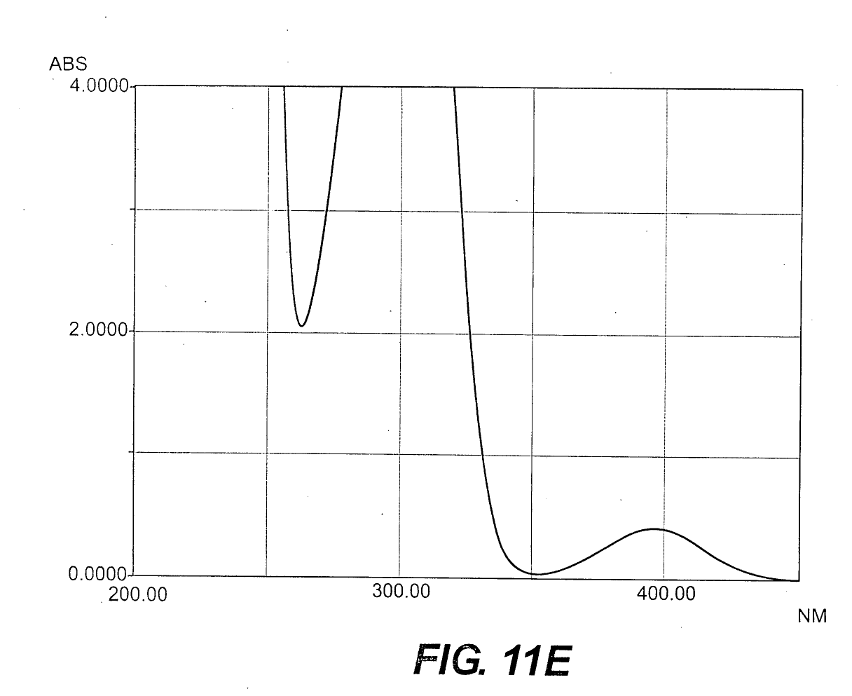

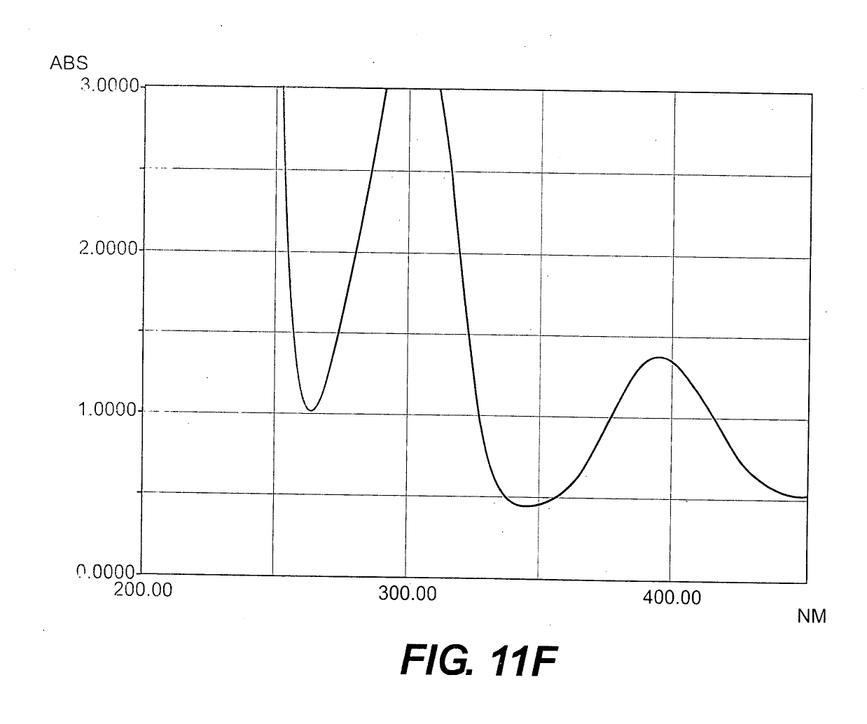

FIGS. 11A-11F are absorption curves showing spectral characteristics of double- and triple-doped nickel fluorosilicate. FIG. 11A: nickel/cobalt fluorosilicate doped with low concentration Pb²⁺. FIG. 11B: nickel/cobalt fluorosilicate doped with low concentration Ca²⁺. FIG. 11C: nickel/cobalt fluorosilicate doped with high concentration Pb²⁺. FIG. 11D: nickel/cobalt fluorosilicate doped with equal concentrations of Pb²⁺and Ca²⁺. FIG. 11E: nickel/cobalt fluorosilicate doped with Pb²⁺ and Ca²⁺ at low Ca²⁺ ratio. FIG. 11F: Potassium nickel sulfate doped with Pb²⁺ and Ca²⁺at high Ca²⁺ ratio.

### DETAILED DESCRIPTION OF THE INVENTION

The present invention provides narrowband crystals useful for UV sensors and filters. The crystals are nickel fluorosilicate (NiSiF₆.6H₂O), nickel fluoroborate (Ni(BF₄)₂.6H₂O) or potassium nickel sulfate (K₂Ni(SO₄)₂.6H₂O) crystals (collectively “the nickel compounds” doped with one, two, or more dopant ions.

FIG. 1 shows a block diagram of a method 100 for producing a narrow band UV filter using nickel compound crystals doped with a dopant ion (i.e., single-doped nickel compound crystals. The method 100 includes the steps of preparing (110) a saturated nutrient solution of a nickel compound and a dopant salt; growing (120) doped crystals from the nutrient solution; and fabricating (130) narrow band UV filter using the doped crystals.

The nickel compound is one of nickel fluorosilicate (NiSiF₆.6H₂O), nickel fluoroborate (Ni(BF₄)₂.6H₂O) and potassium nickel sulfate (K₂Ni(SO₄)₂.6H₂O), all of which are commercially available. In one embodiment, commercially available NiSiF₆.6H₂O, Ni(BF₄)₂.6H₂O, or K₂Ni(SO₄)₂.6H₂O is further purified by re-crystallization before step 110.

The dopant salt is preferably a salt that matches the nickel compound, e.g., a fluorosilicate salt for NiSiF₆.6H₂O, a fluoroborate salt for Ni(BF₄)₂.6H₂O, and a potassium sulfate salt for K₂Ni(SO₄)₂.6H₂O. Examples of the dopant ions include, but are not limited to, Co⁺⁺, Ca⁺⁺, Ba⁺⁺, Sr⁺⁺, Pb⁺⁺, Cu⁺⁺, Ce⁺³, Pr⁺³ , Nd⁺³, Zn⁺⁺, Li⁺, K⁺, Na⁺, Rb⁺, and Cs⁺. The ratio between the nickel compound and the dopant salt is determined based on the desired absorption characteristics of the doped crystals grown out of the solution.

The nutrient solution is prepared at an elevated temperature, preferably in the range of 35° C. to 45° C., and then cooled at a controlled cooling rate. A seed crystal is added to initiate the crystallization process. Crystals are harvested when they reach desired sizes. In one embodiment, the cooling rate is 0.1° C.-5° C./100 hour. In another embodiment, an acid is added to the nutrient solution to keep the pH of the solution in the range of 1-3. The quality of the crystals is controlled by the temperature, the cooling rate, the size of the bath containing the nutrient solution, the quality of seed, and the purity of the starting materials.

In step 120, grown crystals of doped nickel fluorosilicate (NiSiF₆.6H₂O), doped nickel fluoroborate (Ni(BF₄)₂.6H₂O) or doped potassium nickel sulfate (K₂Ni(SO₄)₂.6H₂O) are fabricated into filters using conventional methods. Typically, the crystals are cut into desired sizes, mounted on a support, and shaped into filters of desired shapes. The filters are polished using non-aqueous lubricants such as Linde powder and ethylene glycol. In one embodiment, the narrowband UV filters produced by the method 100 have a transmission window between 200 nm and 300 nm. The transmission window may be further modified by a second dopant as described below.

FIG. 2 shows a method 200 for producing a narrow band UV filter using nickel fluorosilicate, nickel fluoroborate or potassium nickel sulfate crystals doped with two metal ions (i.e., double-doped nickel compound crystals). The method 200 comprises the steps of producing (210) single-doped nickel compound crystals with fluorosilicate, nickel fluoroborate or potassium nickel sulfate crystals and a first dopant salt by a first solution growth procedure, producing (220) double-doped nickel compound crystals with the single-doped nickel compound crystals and a second dopant salt by a second solution growth procedure, and fabricating (230) narrowband UV filter using double-doped crystals obtained from step 220. One skilled in the art would understand that additional solution growth steps may be added to the method 200 to produce nickel fluorosilicate, nickel fluoroborate or potassium nickel sulfate crystals doped with more than two dopant ions.

The single-doped nickel fluorosilicate, nickel fluoroborate or potassium nickel sulfate crystals in step 210 is produced using procedures similar to that described in Method 100. Examples of the first dopant ion include, but are not limited to, Co⁺⁺, Ca⁺⁺, Ba⁺⁺, Sr⁺⁺, Pb⁺⁺, Cu⁺⁺, Ce⁺³, Pr⁺³, Nd⁺³, Zn⁺⁺, Li⁺, K⁺, Na⁺, Rb⁺, and Cs⁺.

The second solution growth procedure is carried out under conditions similar to that of the first solution growth procedure. Briefly, a saturated solution of single-doped nickel compounds (product of step 210, i.e., nickel fluorosilicate, nickel fluoroborate or potassium nickel sulfate crystals doped with a first dopant) is mixed with a saturated solution of the second dopant (the doping solution) at an elevated temperature (e.g., 35° C. to 45° C.) to form a crystallization mixture. A small pre-grown seed crystal was added to the crystallization mixture for the nucleating. The temperature of the crystallization mixture was then lowered gradually (e.g., at a rate of 0.1° C.-5° C./100 hour) to allow crystallization of double-doped nickel compounds. Examples of the dopant metal ions include, but are not limited to, Ca²⁺, Ba²⁺, Sr²⁺, Pb²⁺, Cu²⁺, Ce³⁺, Pr³⁺, Nd³⁺, Zn²⁺, Li⁺, K⁺, Na⁺, Rb⁺, and Cs⁺. The ions can be provided in the form of a salt, such as a carbonate salt, sulfate salt, nitrate salt, chloride salt, chlorate salt, or phosphoric salt. The transmission spectra of the crystallization mixture is determined. The amount of the doping solution in the crystallization mixture can be adjusted until a desired transmission spectra is achieved.

Typically, the amount of the doping solution is in the range of 0.1-5% (v/v), more preferably in the range of 0.5-3% (v/v) of the saturated solution of the single-doped nickel compounds. As used hereinafter, a “low concentration” of the second dopant generally refers to an amount of doping solution in the range of 0-3% (v/v), and a “high concentration” of the second dopant generally refers to an amount of doping solution in the range of 3-5% (v/v).

The doping solution may be a saturated solution of two or more dopants. The total amount of dopants and the ratio among the different dopants may be adjusted to achieve the desired transmission spectra.

In one embodiment, a saturated solution of NiₓCo₍₁₋ₓ₎SiF₆.6H₂O or K₂NiₓCo_{(1-x)(SO}₄)₂.6H₂O is prepared and mixed with a doping solution of PbCO₃, CaCO₃ or a mixture of PbCO₃ and CaCO₃ to form a crystallization mixture.

In step 230, the grown, double-doped nickel compound crystals are fabricated into filters using conventional methods. Similar to step 130 in Method 100, the crystals are cut into desired sizes, mounted on a support, and shaped into filters of desired shapes. The filters may be polished using non-aqueous lubricants such as Linde powder and ethylene glycol.

### EXAMPLES

### Example 1

### Preparation of NiₓCo₍₁₋ₓ₎SiF₆.6H₂O, Crystals

NiₓCo₍₁₋ₓ₎SiF₆.6H₂O crystals are grown in a saturated solution of NiSiF₆ and CoSiF₆. The ratio between the NiSiF₆ and CoSiF₆ affects the absorption characteristics of the NiₓCo₍₁₋ₓ₎SiF₆.6H₂O crystals grown out of the solution. In one embodiment, the NiSiF₆:CoSiF₆ ratio in the solution is between 2:1 and 6:1, preferably between 3:1 and 5:1, and more preferably between 3:1 and 4:1.

NiSiF₆ and CoSiF₆ are synthesized by reactions between their corresponding carbonate salts and hydrofluorosilicic acid. The reactions can be given as follows:

NiCO₃+H₂SiF₆═NiSiF₆+H₂O+CO₂ (1)

CoCO₃+H₂SiF₆═CoSiF₆+H₂O+CO₂ (2)

The reaction mixtures are heated to 80° C. to accelerate the reactions. The reactions are preferably carried out in plastic containers because hydrofluorosilicic acid is erosive to glass containers. After their synthesis, NiSiF₆.6H₂O and CoSiF₆.6H₂O are purified by recrystallizing from water. FIG. 3 is a picture of recrystallized NiSiF₆.6H₂O crystals.

The crystallization of NiₓCo₍₁₋ₓ₎SiF₆.6H₂O is carried out under conditions suitable for growing NiSiF₆.6H₂O crystals. The conditions are described in detail in the U.S. Pat. No. 5,837,054, which is hereby incorporated by reference. In one embodiment, a saturated NiSiF₆/CoSiF₆ solution is prepared at an elevated temperature of 35° C. to 45° C., preferably at about 40° C. The temperature of the solution is then lowered gradually (e.g., at a rate of 0.2° C.-5° C./100 hour) to allow the formation of NiₓCo_{(1-x)SiF}₆.6H₂O crystals.

H₂SiF₆ may be added to the NiSiF₆/CoSiF₆ solution to keep the pH of the solution in the range of 1-3, preferably at pH 2. The low pH environment improves the quality of crystals by stopping nucleation. FIG. 4 is a picture of cobalt doped NiSiF₆.6H₂O (NiₓCo₍₁₋ₓ₎SiF₆.6H₂O) crystals.

### Example 2

### Preparation of K₂NiₓCo₍₁₋ₓ₎(SO₄)₂.6H₂O Crystals

K₂NiₓCo₍₁₋ₓ₎(SO₄)₂.6H₂O crystals were grown in a saturated solution of K₂Ni(SO₄)₂ and K₂CO(SO₄)₂. Commercially available K₂Ni(SO₄)₂ and K₂CO(SO₄)₂ were further purified by recrystallization. The recrystallization was carried out in a temperature controlled thermostat from a water based solution. The pH of the water based solution was kept around 2 by adding H₂SO₄ to the solution. The recrystallization temperature started at 40° C. and was gradually decreased to about 25° C. during crystallization with constant stirring. FIG. 5 is a picture of recrystallized K₂Ni(SO₄)₂.6H₂O crystals.

The crystallization of K₂NiₓCo₍₁₋ₓ₎(SO₄)₂.6H₂O was carried out under conditions suitable for growing NiSiF₆.6H₂O crystals. The conditions are described in detail in the U.S. Pat. No. 5,837,054, which is hereby incorporated by reference. In one embodiment, a saturated K₂Ni(SO₄)₂/K₂Co(SO₄)₂ solution was prepared at an elevated temperature of 35° C. to 45° C., preferably at about 40° C. The temperature of the solution is then lowered gradually (e.g., at a rate of 0.2° C.-5° C./100 hour) to allow the formation of K₂NiₓCo₍₁₋ₓ₎(SO₄)₂.6H₂O crystals.

H₂SO₄ may be added to the K₂Ni(SO₄)₂/K₂Co(SO₄)₂ solution to keep the pH of the solution in the range of 1-3, preferably at pH 2, to improve the quality of crystals by stopping nucleation. FIG. 6 is a picture of cobalt doped K₂Ni(SO₄)₂.6H₂O (K₂NiₓCo₍₁₋ₓ₎(SO₄)₂.6H₂O) crystals.

### Example 3

### Preparation of NiₓCo₍₁₋ₓ₎(BF₄)₂.6H₂O Crystals

NiₓCo₍₁₋ₓ₎(BF₄)₂.6H₂O crystals were grown in a saturated solution of Ni(BF₄)₂ and Co(BF₄)₂. The starting materials, i.e., Ni(BF₄)₂ and Co(BF₄)₂, were individually purified by recrystallization. The recrystallization was carried out in a temperature controlled thermostat from a water based solution. The pH of the water based solution was kept around 2 by adding HF to the solution. The recrystallization temperature started at 40° C. and was gradually decreased to about 25° C. during crystallization with constant stirring. FIG. 7 is a picture of recrystallized Ni(BF₄)₂.6H₂O crystals.

The crystallization of NiₓCo₍₁₋ₓ₎(BF₄)₂.6H₂O was carried out under conditions suitable for growing NiSiF₆.6H₂O crystals. The conditions are described in detail in the U.S. Pat. No. 5,837,054, which is hereby incorporated by reference. In one embodiment, a saturated K₂Ni(SO₄)₂/K₂CO(SO₄)₂ solution was prepared at an elevated temperature of 35° C. to 45° C., preferably at about 40° C. A small pre-grown seed crystal was added to the saturated solution for the nucleation. The temperature of the solution was then lowered gradually (e.g., at a rate of 0.2° C.-5° C./100 hour) to allow crystallization. The crystal grew on the seed, to a size which would allow a filter with a diameter of greater than three centimeters to be fabricated. FIG. 8 is a picture of cobalt doped Ni(BF₄)₂.6H₂O (NiₓCo₍₁₋ₓ₎(BF₄)₂.6H₂O) crystals.

### Example 4

### Fabrication of Filters from NiₓCo₍₁₋ₓ₎SiF₆.6H₂O Crystals

Grown crystals of NiₓCo₍₁₋ₓ₎SiF₆.6H₂O were cut by a string saw into desired sizes. The cylindrical disc filter was fabricated by mounting the crystal on a prefabricated precise circular rod. Crystals were mounded on the rod with wax. The steel rod was then rotated to shape the crystal into desired radius size. Crystal disc was demounted and polished by using a nan-aqueous lubricant, such as Linde powder or ethylene glycol. The doped crystals (NiₓCo₍₁₋ₓ₎SiF₆.6H₂O) showed superior fabricability (in both cutting and polishing) to that of pure crystals (NiSiF₆.6H₂O). A 20 mm diameter and 8 mm thick disc filter fabricated from NiₓCo₍₁₋ₓ₎SiF₆.6H₂O is shown in FIG. 9.

### Example 5

### Thermal and Spectroscopic Characterization of NiₓCo₍₁₋ₓ₎SiF₆.6H₂O Filters

The short and long term stability of NiₓCo₍₁₋ₓ₎SiF₆.6H₂O crystals were studied by differential thermal analysis. The crystals were tested at the rate of 5K/minute heating and were stable well above 100° C. The long term stability was tested by placing the crystals in an oven at 95° C. for 60 hours. No decomposition was detected. As shown in FIGS. 10A and 10B, the spectral transmission of discs prepared from pure nickel NiSiF₆.6H₂O (FIG. 10A) is quite different from the spectral transmission of discs prepared from NiₓCo₍₁₋ₓ₎SiF₆.6H₂O (FIG. 10B). The doped crystal filter blocks the unwanted transmission in the 400-600 nm and 800-1000 nm ranges, and hence increases the efficiency of the filter.

### Example 6

### Preparation of Filters Doped with in Multiple Ions

Approximately 50 ml of saturated NiₓCo₍₁₋ₓ₎SiF₆.6H₂O or K₂NiₓCo₍₁₋ₓ₎(SO₄)₂.6H₂O solution was mixed with 0.5 ml of saturated PbCO₃, CaCO₃, or a mixture of PbCO₃, CaCO₃ solution prepared in HCl. The solutions were prepared at an elevated temperature of 35° C. to 45° C., preferably at about 40° C. A small pre-grown seed crystal was added to the saturated solution for the nucleation. The temperature of the solution was then lowered gradually (e.g., at a rate of 0.2° C.-5° C./100 hour) to allow crystallization.

### Example 7

### Thermal and Spectroscopic Characterization of Pb²⁺— and Ca²⁺-Doped NiₓCo₍₁₋ₓ₎SiF₆.6H₂O and K₂NiₓCo₍₁₋ₓ₎(SO₄)₂.6H₂O Filters

FIGS. 11A-11F show the effect of Pb²⁺ and/or Ca²⁺ doping on the transmission spectra of NiₓCo₍₁₋ₓ₎SiF₆.6H₂O and K₂NiₓCo₍₁₋ₓ₎(SO₄)₂.6H₂O. Compared to the spectral transmission of NiₓCo₍₁₋ₓ₎SiF₆.6H₂O (FIG. 10B), NiₓCo₍₁₋ₓ₎SiF₆.6H₂O further doped with low concentration of Pb²⁺ (0.1-3%, v/v) showed a shift of the transparency window towards the high wave length region (FIG. 11A). In addition, the transparency window was significantly narrowed from 250-350 nm to 330-370 nm. Similarly, NiₓCo₍₁₋ₓ₎SiF₆.6H₂O doped with low concentration of Ca²⁺ (0.1-3%, v/v) shows a narrow window of transparency between 250 and 350 nm with diminishing absorbance in 300 nm region (FIG. 11B); and NiₓCo₍₁₋ₓ₎SiF₆.6H₂O doped with high concentration of Ca²⁺ (3-5%, v/v) shows a narrow window of transparency between 250 and 320 nm (FIG. 11C). The transmission spectra may be further modified by using a combination of ions as the second dopant. For example, NiₓCo₍₁₋ₓ₎SiF₆.6H₂O doped with equal amounts of Ca²⁺ and Pb²⁺ shows a window of transparency between 250 and 350 nm (FIG. 11D). NiₓCo₍₁₋ₓ₎SiF₆.6H₂O doped with Ca²⁺ and Pb²⁺ at a low Ca²⁺ ratio (<0.5) shows a narrow window of transparency between 255 and 275 nm, and a large window of transparency at 350 nm and above (FIG. 11E). K₂NiₓCo₍₁₋ₓ₎(SO₄)₂.6H₂O doped with Ca²⁺ and Pb²⁺ at a high Ca²⁺ ratio (>0.5) shows a narrow window of transparency between 260 and 280 nm (FIG. 11F). These data clearly demonstrate that the transmission/absorbance spectra of single-doped NiₓCo₍₁₋ₓ₎SiF₆.6H₂O and K₂NiₓCo₍₁₋ₓ₎(SO₄)₂.6H₂O can be further tuned to desired ranges by doping with additional ions.

The foregoing discussion discloses and describes many exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A method for producing a crystal with a transmission window in the UV range, comprising
(1) preparing a first saturated nutrient solution of a nickel compound and a first dopant salt; and
(2) incubating the first nutrient solution under conditions suitable for crystal growth,
wherein said nickel compound is selected from the group consisting of nickel silicon fluoride, nickel fluoroborate, and potassium nickel sulfate, and wherein said dopant salt is selected from the group consisting of salts of cobalt, calcium, barium, strontium, lead, copper, germanium, praseodymium, neodymium, zinc, lithium, potassium, sodium, rubidium, and cesium.

2. The method of claim 1, wherein said dopant salt is a salt of cobalt.

3. The method of claim 2, wherein said nickel compound is nickel silicon fluoride, wherein said dopant salt is cobalt silicon fluoride, and wherein said crystal has a formula of NiₓCo₍₁₋ₓ₎SiF₆.6H₂O, where 0<x<1.

4. The method of claim 2, wherein said nickel compound is nickel fluoroborate, wherein said dopant salt is cobalt fluoroborate, and wherein said crystal has a formula of NiₓCo₍₁₋ₓ₎(BF₄)₂.6H₂O, where 0<x<1.

5. The method of claim 2, wherein said nickel compound is potassium nickel sulfate, wherein said dopant salt is potassium cobalt sulfate, and wherein said crystal has a formula of K₂NiₓCo₍₁₋ₓ₎(SO₄)₂.6H₂O, where 0<x<1.

6. The method of claim 1, wherein said nutrient solution is prepared at a temperature in the range of 35° C. to 45° C.

7. The method of claim 1, wherein said conditions suitable for crystal growth comprising gradually lowering the temperature of the nutrient solution at a rate of 0.1° C.-5° C./100 hour under continuous stirring.

8. The method of claim 1, further comprising the step of purifying the nickel compound by re-crystallization.

9. The method of claim 1, further comprising the step of adding a seed crystal to said nutrient solution.

10. A method for producing a crystal with a transmission window in the UV range, comprising
(1) preparing a first saturated nutrient solution of a nickel compound and a first dopant salt; and
(2) incubating the first nutrient solution under conditions suitable for crystal growth to produce doped nickel compound crystals,
(3) preparing a saturated second nutrient solution of the doped nickel compound obtained from step (2) and a second dopant salt; and
(4) incubating the second nutrient solution under conditions suitable for crystal growth,
wherein said nickel compound is selected from the group consisting of nickel silicon fluoride, nickel fluoroborate, and potassium nickel sulfate, wherein said first and second dopant salts are selected from the group consisting. of salts of cobalt, calcium, barium, strontium, lead, copper, germanium, praseodymium, neodymium, zinc, lithium, potassium, sodium, rubidium, and cesium, and wherein said second dopant salt is different from said first dopant salt.

11. The method of claim 10, wherein said first dopant salt is a salt of cobalt and wherein said second dopant salt is a salt of lead or calcium.

12. The method of claim 10, wherein said doped nickel compound obtained from step (2) is one of NiₓCo₍₁₋ₓ₎SiF₆.6H₂O and K₂NiₓCo₍₁₋ₓ₎(SO₄)₂.6H₂O, where 0<x<1, and wherein said second dopant salt is one of PbCO₃, CaCO₃ and a mixture thereof.

13. The method of claim 10, wherein said first and said second nutrient solution is prepared at a temperature in the range of 35° C. to 45° C.

14. The method of claim 10, wherein said conditions suitable for crystal growth comprise gradually lowering the temperature of the nutrient solution at a rate of 0.1° C.-5° C./100 hour under continuous stirring.

15. The method of claim 1, further comprising the step of polishing a crystal produced in step (2) to a desired shape.

16. The method of claim 10, further comprising the step of polishing a crystal produced in step (4) to a desired shape.

17. A crystal produced by the method of claim 1.

18. The crystal of claim 17, wherein said crystal has a transmission window between 200 nm and 300 nm.

19. A crystal produced by the method of claim 10.

20. The crystal of claim 19, wherein said crystal has a transmission window between 200 nm and 300 nm.
